(19) United States
(12) Patent Application Publication
(10) Pub. No.: US 2014/0173034 A1
(43) Pub. Date: Jun. 19, 2014

(54) CONTENT IDENTIFICATION, RETRIEVAL AND ROUTING IN THE INTERNET

(71) Applicant: INTERDIGITAL PATENT HOLDINGS, INC., Wilmington, DE (US)

(72) Inventors: Hang Liu, North Potomac, MD (US); Serhard Doken, Chester Springs, PA (US); Xavier DeFoy, Kirkland (CA); Osama Lotfallah, San Diego, CA (US)

(73) Assignee: INTERDIGITAL PATENT HOLDINGS, INC., Wilmington, DE (US)

(21) Appl. No.: 14/115,310

(22) PCT Filed: May 3, 2012
(86) PCT No.: PCT/US12/36369

§ 371 Date: Mar. 4, 2014

Related U.S. Application Data
(60) Provisional application No. 61/481,969, filed on May 3, 2011.
(60) Provisional application No. 61/490,397, filed on May 26, 2011.
(60) Provisional application No. 61/509,887, filed on Jul. 20, 2011.

(51) Int. Cl. H04L 29/06

(52) U.S. Cl. CPC H04L 65/1059
USPC 709/217

(57) ABSTRACT

A method and apparatus for content identification, retrieval, and routing in the Internet are provided. In the method and apparatus, content is uniquely identified using an object identifier (OID), and the OID is used for routing and retrieving content in an Internet network. Further, in the method and apparatus, OID summarization based on one or more OIDs may be performed, in which Bloom filters are applied to a portion of the one or more OIDs. Furthermore, hash functions may be applied to network node identities to determine location resolver nodes associated with content.

### CROSS REFERENCE TO RELATED APPLICATIONS

This application claims the benefit of U.S. Provisional Application Ser. No. 61/481,969 filed on May 3, 2011, U.S. Provisional Application Ser. No. 61/490,397 filed on May 26, 2011, U.S. Provisional Application Ser. No. 61/509,887 filed on Jul. 20, 2011, and PCT application No. PCT/US2012/036369, filed May 3, 2012, the contents of which are hereby incorporated by reference herein as if fully set forth.

### BACKGROUND

Content retrieval in Internet networks is based on a client-server model. In the client-server model, a client device that is interested in retrieving content may request content based on an Internet Protocol (IP) address of a server that stores the content. The content is then retrieved from the server and provided to the client device. Thus, the client-server model couples the identity of content to the content's storage location and lacks an independent means of identifying content.

Further, as network nodes such as base stations, access points, and routers, become better equipped with storage capability, network nodes are able to cache content that is more readily available to client devices than using content servers. In addition, as network nodes become better equipped with computational capability, the network nodes may utilize their computational capability and any knowledge of their networks to figure out efficient means for retrieving content. However, because the client-server model couples content identity to storage location, the client server model deprives network nodes from using many of these capabilities as they do not have means of identifying content independently of storage location.

It is, therefore, desirable to have a method and apparatus for identifying content independently of storage location. It is also desirable to have a method and apparatus for network nodes to store, retrieve, and route content based on the content's identity.

### SUMMARY

Method and apparatus for content identification, retrieval and routing in Internet networks are provided. In the method and apparatus, a content delivery network (CDN) comprises a first node comprising a first node receiver configured to receive a request for content. In one embodiment, the request for content identifies content using an object identifier (OID) associated the content. In another embodiment, the first node comprises a first node processor configured to determine whether the content is stored in a local cache of the first node based on the OID associated the content. In another embodiment, on a condition that the content is not stored in the local cache of the first node, the first node further comprises a first node transmitter configured to send the request for content to a second node.

Further in the method and apparatus, the network comprises a second node comprising a second node receiver configured to receive the request for content from the first node and a second node processor configured to determine whether a location object (LO) is maintained for the content. In one embodiment, on a condition that an LO is maintained for the content, the second node further comprises a second node transmitter configured to send to the first node an indication of a location for retrieval of the content.

In an additional embodiment, the second node is a location resolver (LR) node and in another embodiment, the first node is configured to determine the second node by applying a hash function to the OID associated with the content to produce a first hash function value and by applying the hash function to an identity associated with each of a plurality of nodes to produce a plurality of second hash function values, and by comparing the first hash function value to the plurality of second hash function values to determine the second node.

In one embodiment, on a condition that the content is stored in the local cache of the first node, the first node transmitter provides the content. In another embodiment, the OID of the content is comprised of type-length-value (TLV) fields.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 shows an object identifier (OID) in accordance with an embodiment;

FIG. 3 shows an OID in accordance with an embodiment;

FIG. 4 shows an example of a network used in the Internet;

FIG. 5 shows a request for content having an integrated IP address and OID;

FIG. 6 shows a method of retrieving content based on an OID;

FIG. 7 shows a method of retrieving content based on an OID;

FIG. 8 shows a method of processing a request for content having a time-to-live (TTL) field;

FIG. 9 shows a hash ring for determining a location resolver (LR) of particular content;

FIG. 10A shows a method of location resolution;

FIG. 10B shows a location object;

FIG. 11 shows a method of requesting content using an LR;

FIG. 12 shows an example of a multi-tier hierarchical Internet network;

FIG. 13 shows hash function rings for a domain and routing areas;

FIG. 14 shows an example of OID summarization;

FIG. 15 shows a summary location object (SLO);

FIG. 16 shows a flow diagram of a method for publishing an SLO;

FIG. 17 shows a flow diagram of a method for retrieving content based on an OID; and

FIG. 18 shows a flow diagram of a method for retrieving content.

### DETAILED DESCRIPTION

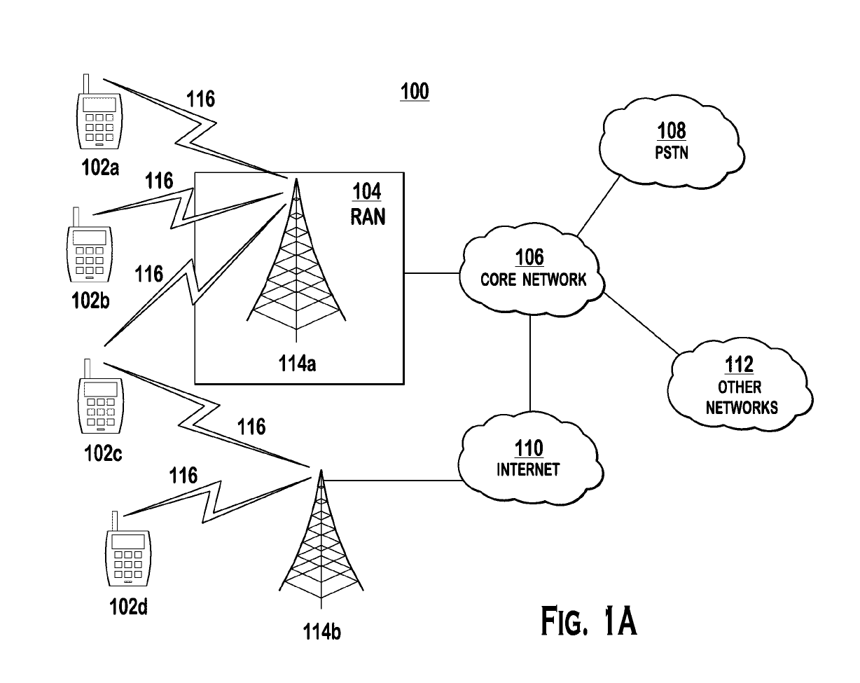

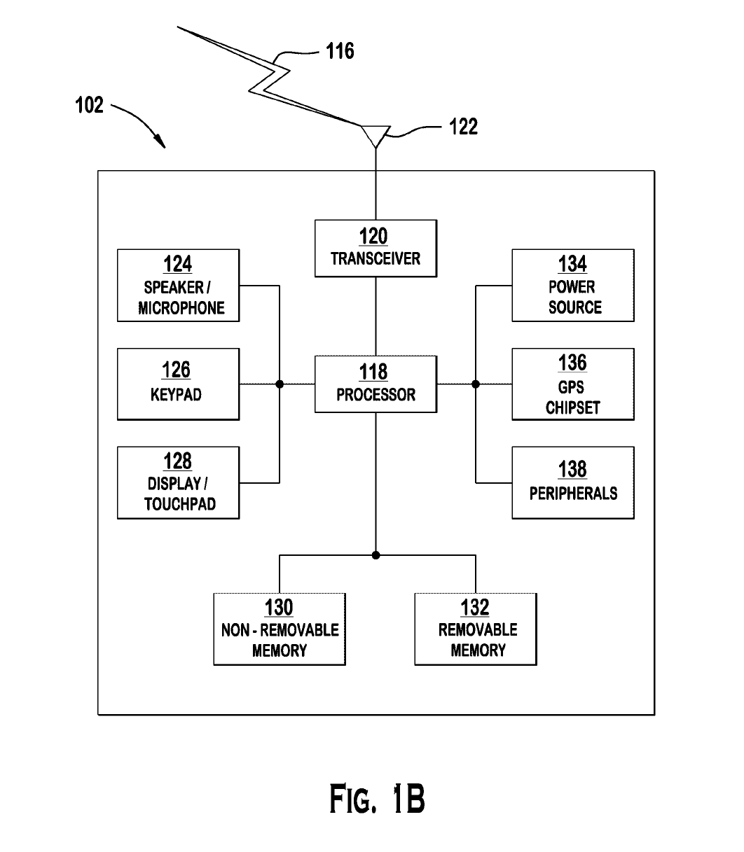

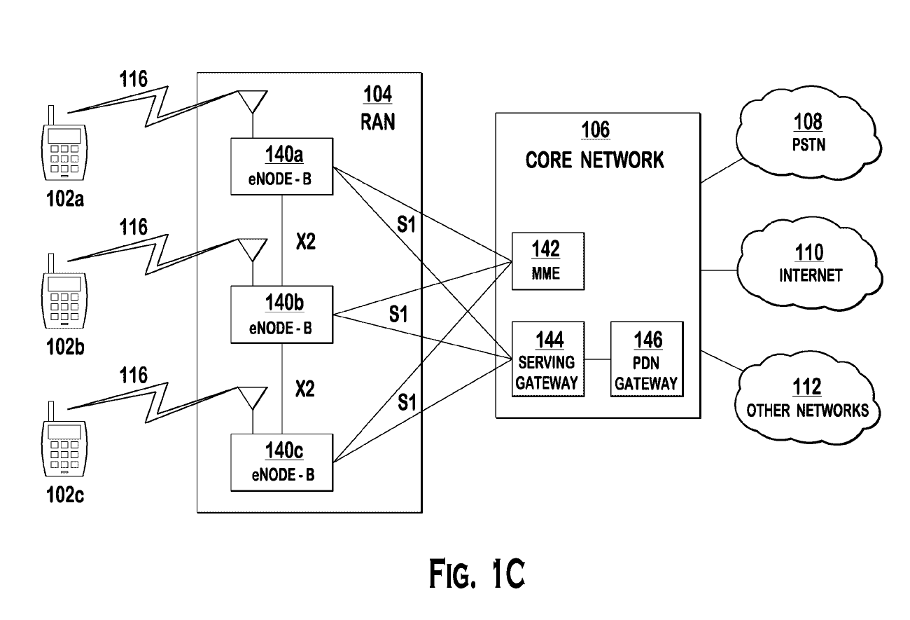

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (for example, radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 142a, 142b, 142c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

Internet content, such as, for example, audio, video, and web pages, may be identified by an object identifier (OID). An OID may uniquely identify a particular content and may be used to refer to the content. Further, devices and users may request the content based on the OID and the network utilize the OID when routing the content. The OID enables the identification of content independent of storage location and is, therefore, unlike models that identify content based on a location in the Internet where the content is stored, (for example, an Internet Protocol (IP) address of a content sever). An OID for content may be set forth by a creator of the content or a publisher of the content. Further, content naming services may be utilized for providing an OID to content, (for example, newly created content).

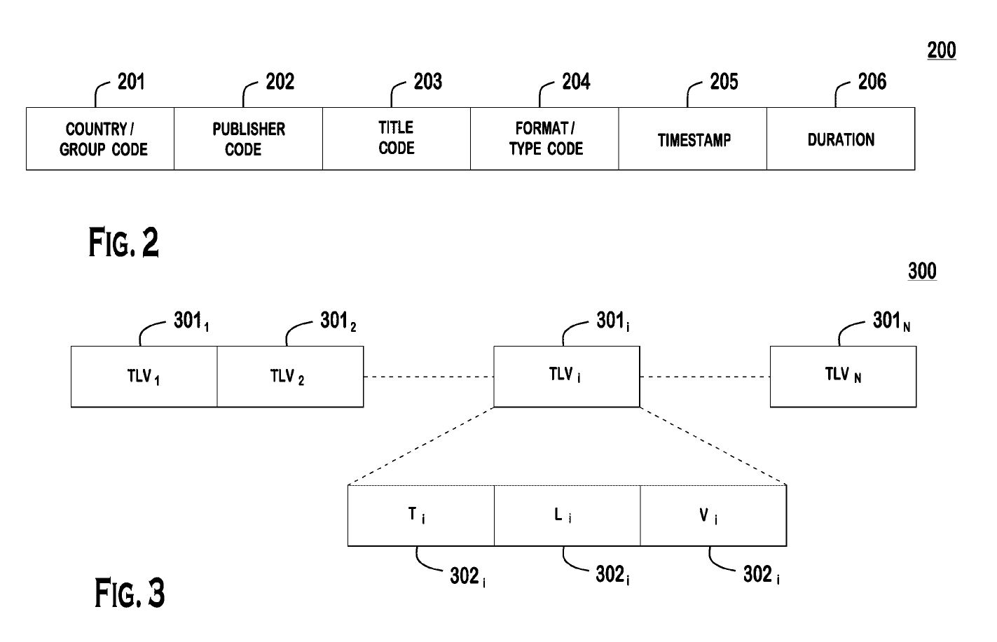

FIG. 2 shows an OID in accordance with an embodiment described herein. The OID 200 comprises a country or group code 201, a publisher code 202, a title code 203, a format or type code 204, a timestamp 205, and a duration 206. The country or group code 201 is a code that is assigned to a country or a group. The country or group code 201 may be the country or group associated with a publisher or creator of the content. The publisher code 202 is a code associated with the publisher of the content. The publisher of the content may, for example, be an electronic content creation service provider. The title code 203 may represent a title for the content. The format or type code 204 may indicate a file format or a type for content. For example, a format or type code 204 may indicate that the content is a text document, a motion picture expert's group (MPEG) encoded video, or more specifically an MPEG-4 encoded video with a particular resolution, among other formats or types. The timestamp 205 indicates a starting time for the content, (for example, for a video or audio file). The duration 206 represents a duration for the content, (for example, a duration for a video or audio segment). The order of the fields 201-206 of the OID 200 may be changed and the OID 200 may include any number of additional fields.

An OID 200 may be human-readable or, alternatively, may be a string of characters that does not have a readable meaning.

FIG. 3 shows an OID in accordance with another embodiment described herein. The OID 300 comprises N type-length-value (TLV) fields 301_{1-N} (referred to collectively hereinafter as TLV fields 301 and singularly hereinafter as TLV field 301ᵢ, where i represents an integer, i=1, 2, . . . , N). Each TLV field 301ᵢ is comprised of a type field 302ᵢ, a length field 303ᵢ, and a value field 304ᵢ. For example, a TLV field 301ᵢ may correspond to any one of the codes 201-206 of OID 200 in FIG. 2.

The type field 302ᵢ represents the type of the TLV field 301ᵢ, (for example, a code or string of characters indicating that TLV field 301ᵢ is a country code, a publisher code, title code, or the like). The length field 303ᵢ represents the length of the value field 304ᵢ. The value field 304ᵢ represents the value of the TLV field 301ᵢ, (i.e., the value pertaining to the type field 302ᵢ of the content). For example, TLV 301ᵢ may represent a movie title, whereby type field 302ᵢ is a code indicating that the TLV 301ᵢ pertains to a movie title and the value field 304ᵢ is a string of characters indicating the title of the movie, (i.e., the title of the content).

The type field 302ᵢ, length field 303ᵢ, and value field 304ᵢ may be concatenated without separation to form the TLV 301ᵢ and the TLV fields 301 may also be concatenated without separation to form the OID 300. The type field 302ᵢ and length field 303ᵢ may be of fixed length, (for example, 2 bytes or octets) and the value field 304ᵢ may be of variable length having any number of bits.

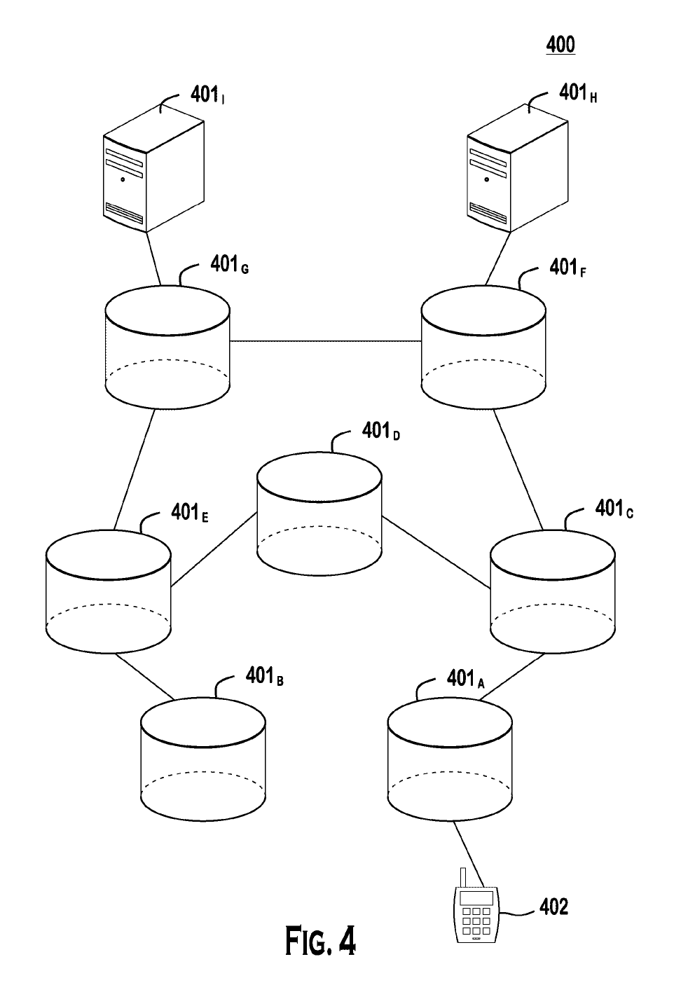

FIG. 4 shows an example of a network used in the Internet. The network 400 is comprised of nodes 401_{A-I} (referred to collectively hereinafter as nodes 401 and singularly hereinafter as node 401ᵢ). The nodes 401 facilitate content delivery for an internet-enabled device 402. After the content is located, the content is provided to the device 402. It is recognized that the Internet is scaled larger than the network 400 depicted in FIG. 4, which is shown for discussion purposes. Furthermore, the network 400 may be one routing area in the Internet that is connected to other routing areas having similar or varying landscapes or topologies. An OID may be used to identify content within the network 400. Further, an OID may be used to identify devices, such as device 402, and nodes 401_{A-I} in the network.

The nodes 401ᵢ may be content servers, such as content servers 401_{H,I} or content routers, such as content routers 401_{A-G}. Content servers 401_{H,I} may store content for access by the device 402. The content servers 401_{H,I} may have IP addresses and the device 402 may request content from the network 400 by identifying an IP address of a content server 401_{H,I} storing the content. Alternatively, the content servers 401_{H,I} may associate stored content with an OID of the content and the device 402 may, therefore, request content from the network based on an OID of the content. Although shown in FIG. 4 as being on the edges of the network 400, the content servers 401_{H,I} may be anywhere in the network 400.

Content routers 401_{A-G} may route traffic, (for example, content and requests for content), between the device 402, content servers 401_{H,I}, and other content routers 401_{A-G}. Thus, upon receiving a request for content, content routers 401_{A-G} may route the request for content to an intended node. Examples of content routers 401_{A-G} include Institute of Electrical and Electronics Engineers (IEEE) 802.11 access points (APs), and LTE eNBs, among others.

In addition to simply routing traffic in the network 400, content routers 401_{A-G} may also cache content by storing a local copy of the content on-site. For example, content routers 401_{A-G} may store a local copy of frequently requested or trafficked content. By doing so, content routers 401_{A-G} may be able to more readily provide the content to a requesting party, (for example, device 402, or another node 401ᵢ). Content routers 401_{A-G} may provide the content to the requesting party without an additional delay incurred in fetching the content from an intended node, (for example, a content server 401_{H,I} or another node 401ᵢ elsewhere in the network 400).

Some networks, such as network 400, may be all OID-equipped whereby all the nodes of the network are capable of processing OIDs. However, other networks may be integrated networks that utilize IP addressing and OIDs for content identification and retrieval. In the integrated networks, a node may be capable of processing OIDs and retrieving content based on the content's OID, processing IP addresses and retrieving content based on an IP address of where the content is stored, or processing both OIDs and IP addresses and retrieving content based upon any combination of the content's OID or an IP address of where the content is stored. It is noted that a node that is not capable of processing OIDs may connect to an OID-capable node as a client and thus be able to receive OID services.

A network node, for example, a content router 401_{A}, may comprise several physical layer and link layer interfaces, a cache, and a forwarding and storage engine. A network node may also comprise a functional unit for OID processing and resolution and a functional unit for IP routing.

The device 402 may retrieve content from the network 400 by sending a request for content to the network 400, (for example, the device 402 may send the request for content to node 401_{A}). The request for content may be routed and propagated by the nodes 401ᵢ of the network 400. The request for content may identify content using an IP address, an OID, or both an IP address and an OID.

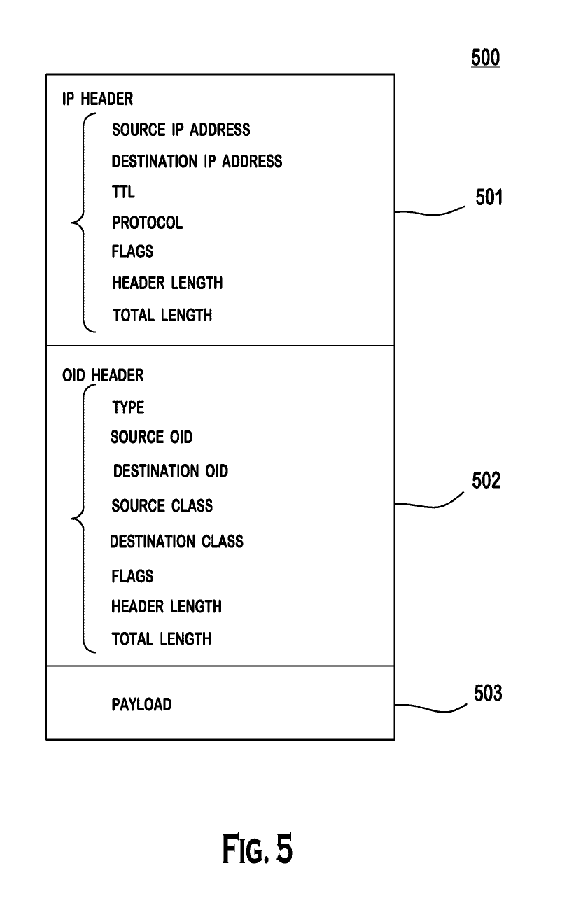

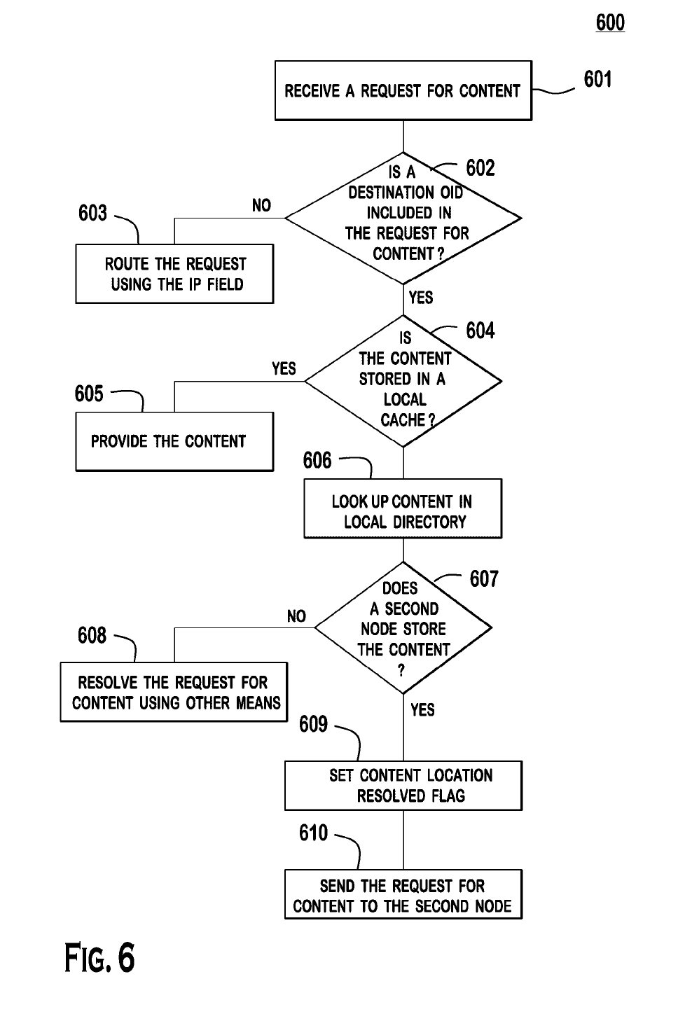

FIG. 5 shows a request for content having an integrated IP address and OID. The request for content 500 has an IP field 501, an OID field 502, and a payload 503. The IP field 501 may include a source IP address, which identifies the IP address of the party requesting the content, and a destination IP address, which identifies the IP address of a party to which the request is intended. The destination IP address may be an address of a node storing the content, or an address of another node, for example, an intermediary node in the network.

The IP field 501 may include a field length which indicates the length of the IP field 501 and a total length which indicates the length of the request for content 500. The IP field 501 may also include a protocol field which identifies whether an OID field 502 is included in the request for content 500. Further, the IP field may include a time-to-live field, and any number of flags, which are used for routing the request for content and which are described in more detail herein.

The OID field 502 may include a source OID, which indicates the OID of the party requesting the content and a destination OID, which indicates the OID of the desired content, or a network node storing the content. The OID field 502 may include a field length which indicates the length of the OID field 502 and a total length which indicates the length of the request for content 500. The OID field 502 may also include a type field, which indicates whether the destination OID is present. The OID field 502 may further include a source class, which indicates whether the source OID is a user end-device like device 402 of FIG. 4, or a network node, and a destination class, which indicates whether the destination OID is an OID associated with content or a network node. Additionally, the OID field 502 may include any number of flags or indicators that are described in more detail herein. The payload 503 of the request for content 500 may include any general purpose data and control information.

A device may use the request for content 500 for content retrieval. If the device is aware of the IP address of a node in the network that stores the requested content, the device may include the IP address of the node in the destination IP address field in the IP field 501. However, if the device does not know the IP address of the node that stores the requested content, the device may include a broadcast IP address, or a multicast IP address. The broadcast IP address or the multicast IP address may result in the request for content being delivered to one or multiple nodes as dictated by the broadcast IP address or multicast IP address. The destination IP address may also be an address of any node in the network to which the request for content is directed.

If the device knows the OID of the requested content, the device may include the OID in the destination OID field of the OID field 502. If the device does not know the OID of the requested content, the device may include a null value in the destination OID field. Further, if the device does not know the OID of the content, a search may be performed for the OID based on information such as a title, an author, or keywords of the requested content. The device may include the device's OID in the source OID of the OID field 502.

Referring back to FIG. 4, nodes in a network may exchange among each other the OIDs of content that the nodes 401 store. Based upon the exchanged OIDs, a node, for example, node 401_{A}, may develop a local directory associating an OID with another node, for example, node 401_{B}, that stores the content of the OID. Thus, upon receiving a request for content, node 401_{A} may route the request for content to node 401_{B} that stores the content and the content may be retrieved more readily from node 401_{B}.

As may be recognized, content retrieval based on an OID offers flexibility compared to content retrieval using an IP address of where the content is stored. OIDs offer unique identification of content and, thus, lend the nodes 401 the capability to improve efficiency in content retrieval.

FIG. 6 shows a method of retrieving content based on an OID. A first node receives a request for content 601. The request for content may have an integrated IP address and an OID. The first node determines whether a destination OID is included in the request for content 602. The first node may determine whether a destination OID is included by checking the protocol field in the IP field, for example, IP field 501, or the type field in the OID field, for example, OID field 502, of the request for content. If a destination OID is not included in the OID field of the request for content, the first node routes the request for content using the IP field. If a destination OID is included, the first node determines whether the content is stored in the first node's local cache 604. If the content is stored in the first node's local cache, the first node provides the content to the node or device that requested the content 605.

If the content is not stored in a local cache, the first node looks-up the content in a local directory 606 and determines whether a second node stores the content 607. If the first node determines that the content does not match an entry in the local directory, first the node resolves the request for content using other means 608 described herein.

If the first node determines that a second node stores the content, the node may set a flag (referred to herein as a content location resolved flag) in the OID field of the request for content 609. The content location resolved flag indicates that the location of the content has been resolved and may be used by intermediary nodes as described herein.

The first node then sends the request for content to the second node 610. The first node may send the request for content to the second node by including the second node's IP address in the destination IP address of the IP field of the request for content. The first node may determine that there are multiple nodes that either store the content or know where the content is stored and may determine whether to send the request for content to one or more of the multiple nodes. A multicast IP address may be used for the purpose of sending the request for content to multiple nodes.

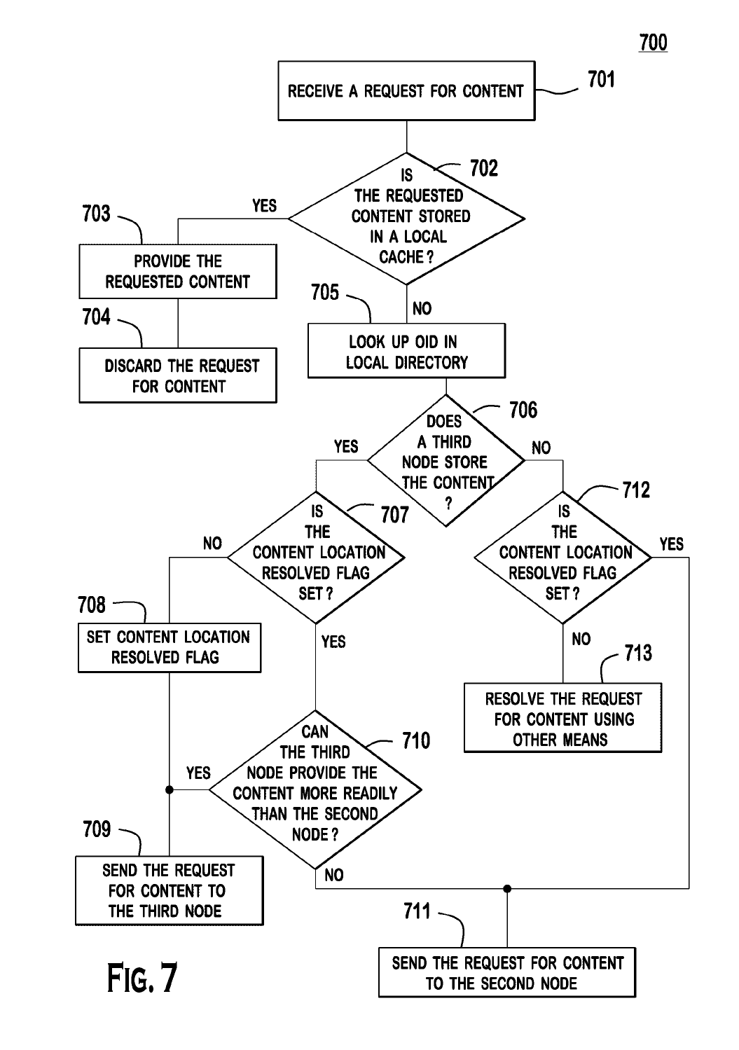

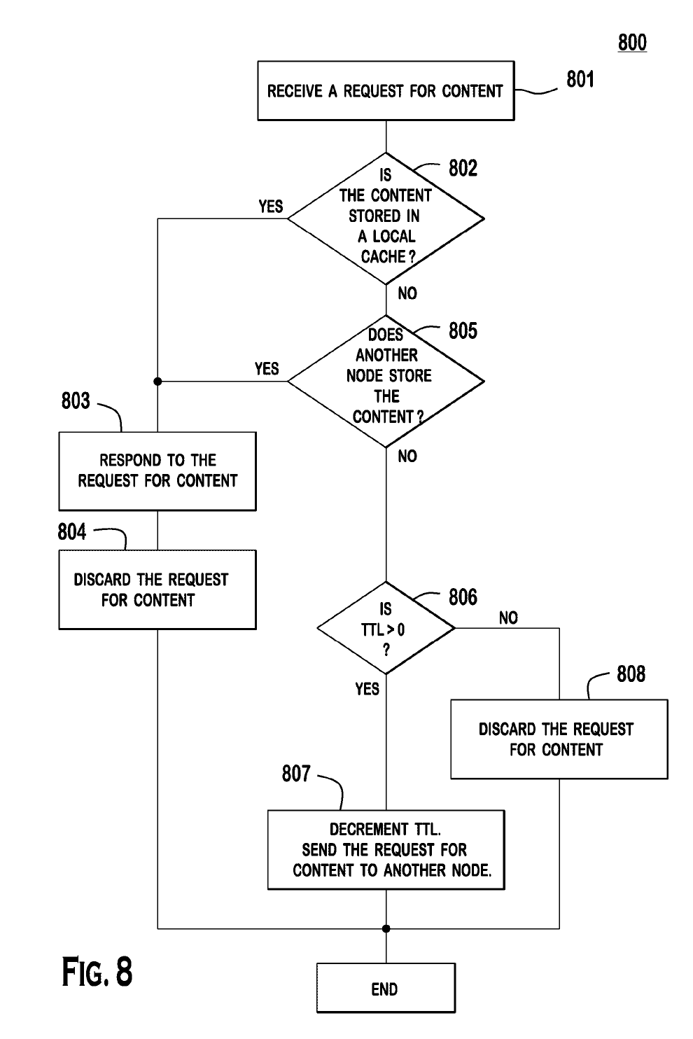

A request for content for which the content location resolved flag is set may reach the second node without passing any intermediary nodes, (i.e., a one-hop connection exists), or may be received by an intermediary node before reaching the second node. If the request for content is received by an intermediary node, the intermediary node may determine whether the requested content may be provided more readily by the second node or by another node within the network, as described with reference to FIG. 7 herein.

FIG. 7 shows a method of retrieving content based on an OID. An intermediary node receives a request for content 701. The intermediary node determines whether the requested content is stored in a local cache 702. If the requested content is stored in the local cache, the node intermediary provides the requested content 703 and discards the request for content 704, (i.e., the request for content does not reach the second node). If the requested content is not stored in the local cache, the intermediary node performs an OID look-up in a local directory 705 and determines whether a third node within the network stores the content 706.

If a third node stores the content, the intermediary node then determines whether the content location resolved flag is already set 707. If the content location flag is not already set, the intermediary node sets the content location resolved flag 708 and sends the request for content to the third node 709. If the content location resolved flag is already set, the intermediary node determines whether the third node is able to provide the content more readily than the second node 710, whereby if a positive determination is made then the intermediary node sends the request for content to the third node 709 and if a negative determination is made then the intermediary node sends the request for content to the second node 711.

If after performing a look-up in a local directory, the intermediary node is unsuccessful in locating a node that stores the content, the intermediary node determines whether the content location resolved flag is set 712. If a positive determination is made, the intermediary node sends the request for content to the second node 711. If a negative determination is made, the intermediary node resolves the request for content using other means 713.

If a node is unsuccessful in locating the storage location of content, the node may propagate a request for content to other nodes in the network to inquire whether the content is stored in other nodes in the network. Because propagating requests for content may quickly overwhelm the network and cause increased traffic and congestion due to the requests, a node propagating a request for content may set an expiration of the request. Nodes that receive the request for content may only acknowledge the request if the request has not expired. If the request has expired, on the other hand, the nodes that receive the request may simply discard the request. Therefore, requests for content are prevented from congesting the network.

A request for content may be set to expire after a specified number of hops, (i.e., the number of network nodes that handle the request), or after a specified time period. The time-to-live (TTL) field of the IP field of the request for content may be set to a value indicating the expiry. If the TTL is specified according to the number of hops the request for content takes, each receiving node may decrement the TTL field and forward the request for content, as described with reference to FIG. 8 herein.

FIG. 8 shows a method of processing a request for content having a TTL field. A first node receives a request for content 801. The first node determines whether the content is stored in a local cache 802. If the content is stored in a local cache, the first node responds to the request for content 803, (for example, by providing the requested content), and discards the request for content 804. If the content is not stored in a local cache, the first node determines whether a second node stores the content 805, (for example, by looking-up the OID in a local directory). If the first node determines that a second node stores the content, the first node responds to the request for content, (for example, by providing an address of the second node), and discards the request for content. If, however, the first node determines that it is not aware of other nodes that store the content, then the first node determines whether it may propagate the request for content or if the request for content has expired. To do so, the first node determines whether the TTL field is greater than zero 806. If the TTL field is greater than zero, then the first node decrements the TTL field and sends a request for content to other nodes in the network 807, (for example, by using broadcast or multicast). If the first node determines that the TTL field is not greater than zero, then the request for content has expired and the first node discards the request for content 808.

When an initiating node issues a request for content with a TTL field set to a particular value and specified according to the number of hops the request for content takes, if the initiating node does not receive a response to the request for content before the expiration of the TTL, the initiating node may increment the TTL and reissue the request for content. Incrementing the TTL allows more nodes to receive the reissued request for content and increases the likelihood of finding the content. An initiating node may increment the TTL field of the request for content by discrete increments each time the request for content is reissued, (for example, by setting TTL=TTL+D, where D is a discrete value). Alternatively, an initiating node may further increase the TTL field by multiplying the TTL by a constant value each time the request for content is reissued, (for example, by setting TTL=TTL*K, where K>1). In addition, an initiating node may impose a limit on the number of times the request for content is reissued.

A node in a network, for example network 400 of FIG. 4, may be aware of the presence of other nodes in the network. In addition, a node may have information about the identities, (for example, IP addresses), and the capabilities, (for example, presence of a local cache, presence of a local directory, ability to process an OID, or ability to process an IP address) of other nodes in the network. For example, a node may advertise its own capability and identity and receive information about the capability and identity of other nodes in the network. Sharing information between nodes may be done via a link-state protocol, such as open shortest path first (OSPF) for intra-domain routing, border gateway protocol (BGP) for inter-domain routing or intermediate system to intermediate system (IS-IS).

Knowing the identity and capability of nodes in a network enables the distribution and load-balancing of content routing and retrieval among the nodes. A node may be designated as a location resolver (LR) of particular content and may be assigned the responsibility of identifying the location of where the content is stored. A node may be designated as an LR of particular content based on the OID of the content.

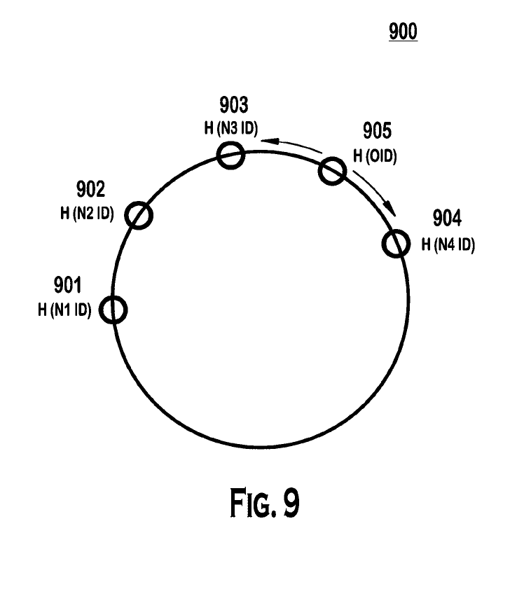

A hash function may be applied to the identities, (for example IP addresses or OIDs), of all known network nodes. A hash function, as is known in the art, is a subroutine that is utilized in mapping a large data set to a smaller data set. The application of the hash function to the identities of known network nodes will result in the creation of a hash ring as described with reference to FIG. 9 herein. The hash function may be also applied to the OID of content. The LR of particular content is determined based on the hash function values of the identities of networks nodes and the OID of the content.

FIG. 9 shows a hash ring for determining the LR of particular content. In the hash ring 900, a hash function, H(x), is applied to the identities of nodes of the network, Ni ID, to generate hash function values, H(Ni ID) 901-904, for each node in the network. Further, the hash function is also applied to the OID of the content to generate a hash function value H(OID) 905. In FIG. 9, H(OID) 905 lies between H(N3 ID) 903 and H(N4 ID) 904.

The LR may be determined to be the node whose identity is N3 ID because the H(N3 ID) 903 is the closest hash function value of node identities not exceeding H(OID) 905. Other criteria may be used to determine the LR. For example, the LR of the content may be determined to be the two nodes whose identities are N3 ID and N4 ID because H(N3 ID) 903 and H(N4 ID) 904 are the closest to H(OID).

The hash ring 900 of FIG. 9 may be a distributed hash table (DHT) and the formation of the hash ring 900 may be facilitated by the fact that nodes in a network are aware of the identities and capabilities of other nodes in the network, for example, using OSPF or BGP information. Further, all nodes in the network may be able to form the hash ring 900 and utilize it for content routing and retrieval. The hash ring 900 of FIG. 9 may also be said to be one-hop because a node is able to directly determine an LR node without the need to utilize an intermediary node.

When a node desires to retrieve content with a particular OID, the node may determine the LR node for the content by applying the hash function as shown with reference to FIG. 9. The node may request from the LR node information regarding where in the network the content is stored. The LR may supply this information to the requesting node and the requesting node may request the content from the node that stores the content.

Because different content has varying OIDs and the hash function values of varying OIDs may be different or the same, utilizing a hash function for determining the LR of content uniformly distributes location resolution tasks in the network.

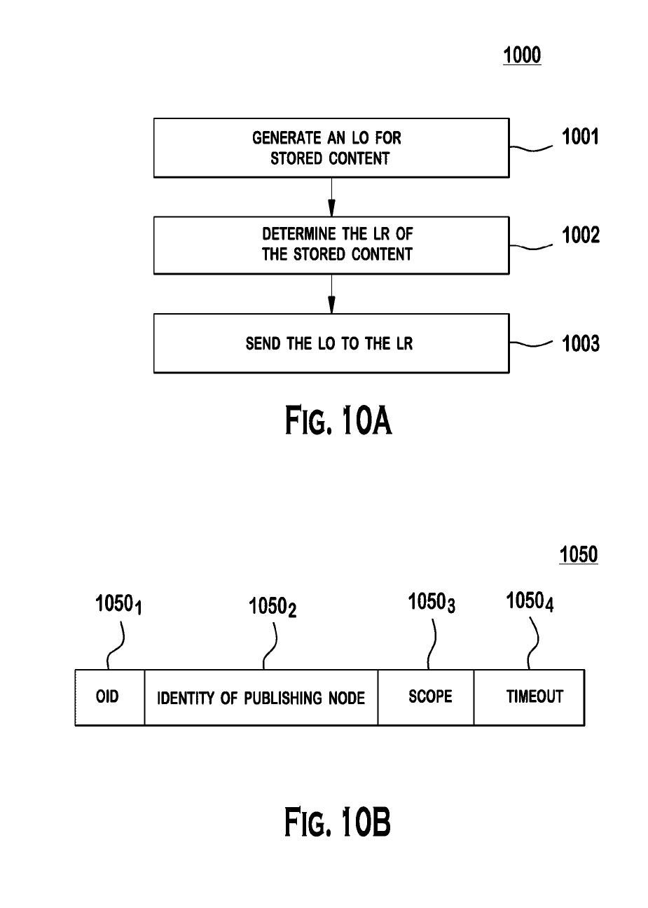

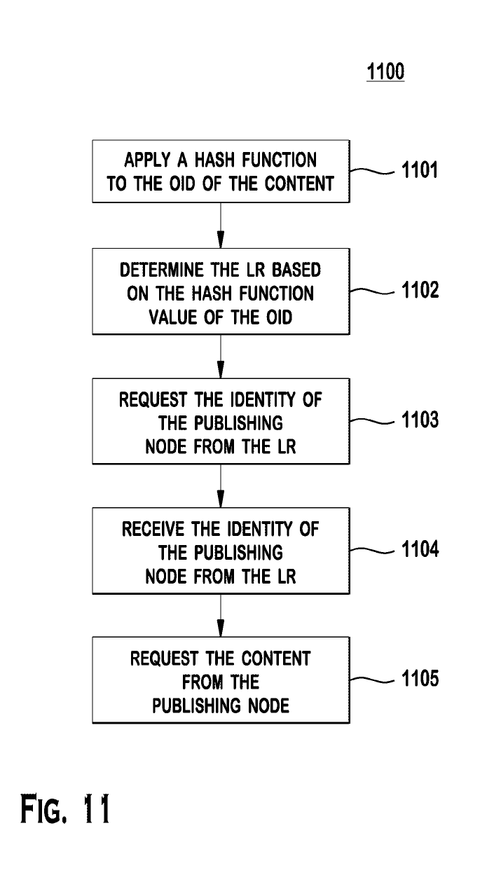

A publishing node that is aware of the storage location of content may determine the LR of that content based on the OID. The publishing node may send information to the LR indicating that the publishing node is aware of the storage location of the content, as described with reference to FIG. 10A herein. The information, referred to as a location object (LO), may include the OID of the content and the identity of the publishing, among other parameters. The LR retains the LO and supplies the LO to nodes that are interested in retrieving the stored content using the publishing node.

FIG. 10A shows a method of location resolution. In the method, a publishing node generates a location object (LO) for the stored content 1001. FIG. 10B shows a location object 1050. The LO 1050 may include the OID of the stored content 10501, an identity of the publishing node 10502, a scope field 10503, and a timeout field 10504. The scope field 10503 may indicate any limitation on publication of the LO 1050, (i.e., any restriction on who may know that the content is published). The timeout field 10504 may indicate a valid time for the LO 1050, (i.e., after the timeout expires the node no longer stores the content).

Referring back to FIG. 10A, once the LO 1050 for the stored content is generated 1001, the node determines the LR of the stored content by applying a hash function to the OID of the stored content and selecting as LR the node whose H(N ID) is closest but not exceeding the hash function value of the OID. After determining the LR, the node sends the LO 1050 to the LR 1003.

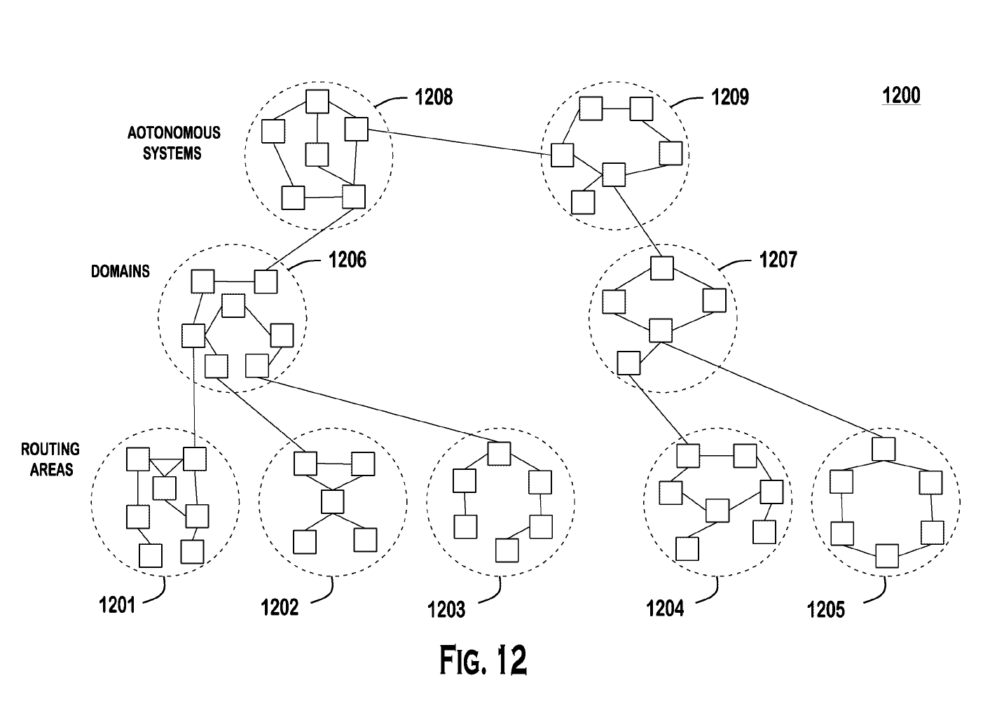

FIG. 11 shows a method of requesting content using an LR. A node that is interested in locating content applies a hash function to the OID of the content 1101. The node may then determine the LR of the content based on the hash function value of the OID 1102, (for example, by applying a hash function to the OID of the stored content and comparing the hash function value of the OID with the hash function value of node identity). The node may then request the identity of the publishing node from the LR 1003. The LR may check the LO and provide the identity of the publishing node to the requesting node. Alternatively, the LR may provide the entire LO to the node. The node receives the identity of the publishing node from the LR 1004. The node requests the content from the publishing node 1005. The publishing node may retrieve the content and provide the content to the node.

As previously described, the scale of the Internet is larger than shown in FIG. 4. Further, an Internet network may comprise multi-tier hierarchical networks and may have various autonomous systems, domains, or routing areas. Accordingly, the network of FIG. 4 may also be a routing area, a domain, or an autonomous system in an Internet network. FIG. 12 shows an example of a multi-tier hierarchical Internet network. In the network 1200, routing areas 1201-1205 comprise connected nodes. The routing areas 1201-1203 are the lowest tier in the network 1200. Routing areas 1201-1203 are connected to domain 1206 and routing areas 1204, 1205 are connected to domain 1207. The domains 1206, 1207 also comprise connected nodes. Domain 1206 is connected to autonomous system (AS) 1208 and domain 1207 is connected to AS 1209. AS 1208 and AS 1209 also comprise connected nodes. AS 1208 and AS 1209 are peering as shown by their connectivity. It is recognized that the network 1200 may have additional AS tiers that are not shown in FIG. 12. The network 1200 may be an IP network that is deployed and equipped with OID processing capability without modifying an underlying IP structure of the network 1200. Further, the network 1200 may be a content-oriented network (CON), a content delivery network (CDN), or an information-centric network (ICN), where OID services co-exist with other IP services such as host-to-host communications.

Hash functions may be used in producing hash function rings in any one of the tiers (for example, routing area, domain, or AS) of network 1200 as described herein.

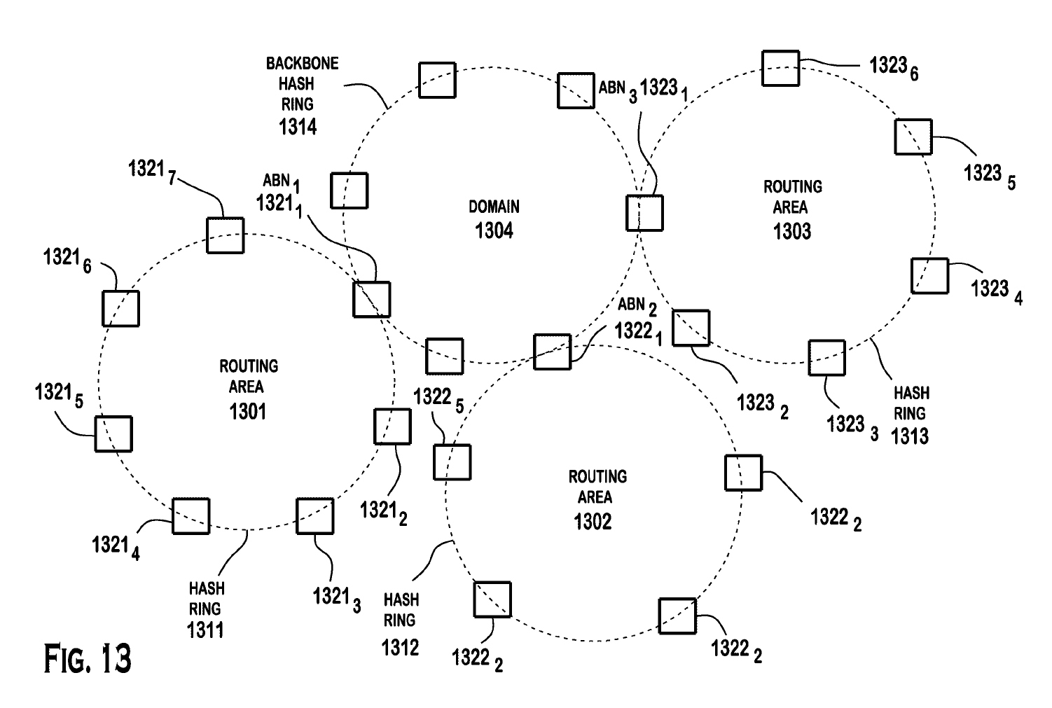

FIG. 13 shows hash function rings for a domain and routing areas. Routing areas 1301-1303 in FIG. 13 correspond to routing areas 1201-1203 in FIG. 12 and domain 1304 in FIG. 13 corresponds to domain 1206 in FIG. 12. In FIG. 13, each routing area 1301-1303 has nodes that are part of the routing area's respective hash ring 1311-1313. Routing area 1301 has nodes 1321₁₋₇ that are part of hash ring 1311, routing area 1302 has nodes 1322₁₋₅ that are part of hash ring 1312, and routing area 1303 has nodes 1323₁₋₆ that are part of hash ring 1313. As previously described, the hash rings 1311-1313 are generated by applying a hash function to the identities of nodes 1321₁₋₇, 1322₁₋₅, and 1323₁₋₆, respectively.

Routing areas 1301-1303 are connected to domain 1304. Further, the domain 1304 has a backbone hash ring 1314 that is also generated by applying the hash function to the nodes of the domain 1304. An area border node (ABN) 1321₁-1323₁ is designated where the routing areas 1301-1303 connect to the domain 1304. The ABN 1321₁-1323₁ is shared between a routing area's hash ring 1311-1313 and a domain's backbone hash ring 1314.

The backbone hash ring 1314 for the domain 1304 and the hash rings 1311-1313 of the routing areas 1301-1303 of FIG. 13 are said to form a multi-level distributed hash table (DHT) which reflects the topology of the associated domain 1304 and routing areas 1311-1313. At the routing area tier, a DHT if formed using OSPF link state information. Further, a backbone DHT is formed at the domain tier for intra-routing area routing. A node, for example, ABN 1321₁, that is connected to domain 1304 and routing area 1301 may join the backbone DHT of the domain 1304 and the DHT of the routing area 1301.

For inter-domain routing (not shown in FIG. 13), multi-level DHTs may be formed using the information provided by BGP that reflects the Internet hierarchy and peering relationship among Autonomous Systems (ASes). A node may join multiple DHTs, and the DHTs may be interconnected in a tree-like form with multi-homing. Location information of content object is published in the multi-level DHTs and at each level summarization may be performed based on content popularity and DHT level.

ABNs 1321₁-1323₁ may be utilized for facilitating content retrieval between routing areas 1301-1303 and the domain 1304. An ABN 1321₁-1323₁ may summarize the OIDs of content stored in the ABN's routing area 1301-1303. The summarization of OIDs may serve to indicate to other routing areas and the domain whether content is stored within the ABN's routing area.

An LR node, for example, node 1321₂, in an ABN's routing area, for example, ABN₁ 1321₁ in routing area 1301, may provide the OIDs of LOs it maintains to the ABN 1321₁. Having received the OIDs from LR node 1321₂ in its routing area, the ABN may receive requests for content from other routing areas, for example, routing areas 1302-1303, and indicate whether or not the content sought is stored in the ABN's routing area 1301 based on whether the ABN 1321₁ retains the OID of the content sought. However, maintaining an exhaustive list of OIDs for all content stored in a routing area 1301 may strain the computational and storage resources of the ABN 1321₁. Further, OID traffic may consume extensive bandwidth in a network. To enable efficient content location and retrieval, OID summarization may be employed, whereby summary OIDs may be sent to and retained by the ABN 1321₁. OID summarization uses common fields of OIDs to improve efficiency. OID summarization may utilize Bloom filters that are know in the art.

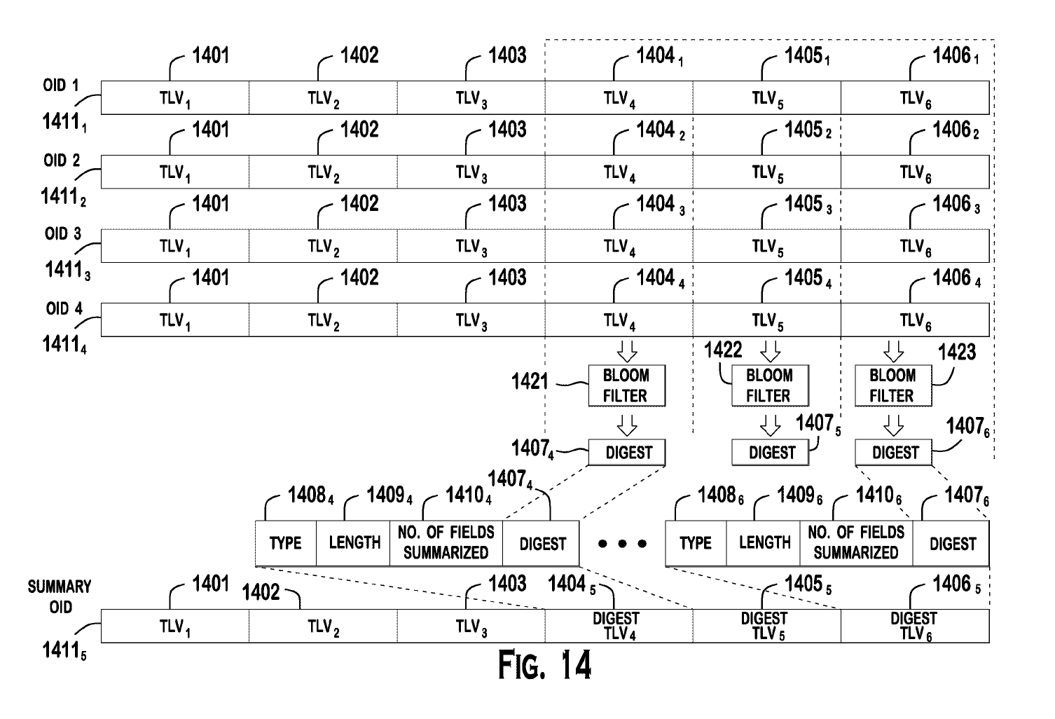

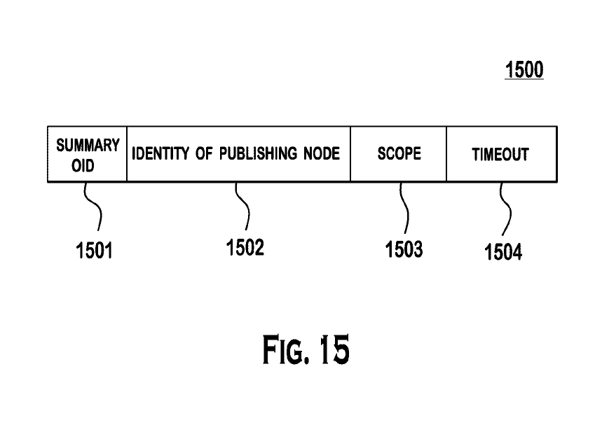

FIG. 14 shows an example of OID summarization. OIDs 1-4 1411₁₋₄ each have six TLVs, TLV₁₋₆ 1401-1403, 1404₁₋₄-1406₁₋₄. At least TLV₁₋₃ 1401-1403 are the same for the OIDs 1411₁₋₄. TLV₁₋₃ 1401-1403 are referred to as prefix TLVs. TLVs TLV₄₋₆ 1404₁₋₄-1406₁₋₄ (referred to as suffix TLVs), however, may be different. A summary OID 1411₅ is generated by retaining the prefix TLV, TLV₁₋₃ 1401-1403, and applying Bloom filters 1421-1423 to the suffix TLVs TLV₄₋₆ 1404₁₋₄-1406₁₋₄ to produce digests 1407₄₋₆, respectively. The digests 1407₄₋₆ are then appended with a type field 1408₄₋₆, a length field 1409₄₋₆, and a number of fields summarized field 1410₄₋₆ to produce digest TLV₄₋₆ 1404₄₋₆.

A summary OID 1411₅ generated using Bloom filters may be queried or tested to determine whether an OID of interest is one of the OIDs 1411₁₋₄ used to generate the summary OID 1411₅. The result of a Bloom filter test may be negative, (i.e., indicating that an OID of interest was not used in generating the summary OID 1411₅), or positive, (i.e., indicating that the OID of interest was in fact used in generating the summary OID 1411₅). However, the cost of TLV summarization using Bloom filters is that a false positive may occur, (i.e., a test determining that the OID of interest was used in generating the summary OID 1411₅, when in fact the OID was not used in generating the summary OID 1411₅). A false negative, on the other hand, may not occur in Bloom filters. Further, the likelihood of a false positive query or test outcome increases as the number of OIDs 1411₁₋₄ summarized increases.

To control the likelihood of false positives, limits may be imposed on the number of OIDs 1411₁₋₄ used in generating a summary OID 1411₅. Further, when the number of OIDs 1411₁₋₄ summarized is higher than a limit, multiple digest TLVs, may be generated for each TLV field. Each of the digest TLVs 1404₄₋₆ associated with a TLV field 1404₁₋₄-1406₁₋₄ may be tested to determine whether an OID was used in generating the digest TLVs 1404₄₋₆.

An LR node may summarize the OIDs 1411₁₋₄ of content for which it retains LOs and generate a summary OID 1411₅. Similar to an LO that is generated based upon an OID, an LR node may generate a summary location object (SLO) based upon the summary OID 1411₅.

FIG. 15 shows an SLO. The SLO 1500 comprises a summary OID 1501, an identity of publishing node 1502, a scope field 1503, and a timeout field 1504. As with an LO, the scope field 1503 represents the manner in which the SLO 1500 may be published, (for example, routing areas, domains, or autonomous systems that may know that the content is stored and may be able to request it), and the timeout field 1504 represents an expiration of the storage of the content associated with the SLO 1500. It is noted that content having differing scopes and timeouts may be grouped according to their respective scopes and timeouts, and the OIDs of the content may be summarized accordingly, thus facilitating meaningful SLO 1500 generation.

An LR node may generate SLOs for content for which the LR node retains LOs. The LR node may provide the SLOs to an ABN of the LR node's routing area. Additionally, the ABN may receive SLOs from other LRs in the ABN's routing area. The ABN may further summarize the summary OIDs of the SLOs it receives from LRs within the ABN's routing area. For further summarization, prefix TLVs are retained whereas digests of digest TLVs are “ORed”, (i.e., by applying a logical disjunction function), for producing a new summary OID. The ability to further summarize OID using a logical disjunction function is due to the nature of the Bloom filters that generate the digest TLVs.

For example, the ABN may receive two SLOs having summary OIDs with the same prefix TLVs but differing digest TLVs. The ABN may further summarize the two SLOs by retaining the prefix TLVs and generating new digest TLVs based on ORing the digests of the digest TLVs.

In a backbone hash ring, SLOs may be distributed among the nodes, (for example, ABNs), of the backbone hash ring using a hash function. The distribution of the SLOs among the nodes of the backbone hash ring facilitates the load balancing of content retrieval tasks. For a particular SLO, a node in the backbone hash ring is designated as a backbone location resolver node (BLRN). The BLRN stores the SLO 1500 and services requests for content for the SLO 1500. The BLRN may service request for content from any routing area connected to the backbone hash ring or other domains and autonomous systems.

When a node in the backbone hash ring, (for example, an ABN), receives an SLO, the node determines a backbone location resolver node (BLRN) in a backbone hash ring that is designated to store the SLO. As with determining an LR for a particular LO, to determine a BLRN node for an SLO a hash function is applied to the prefix TLVs, (i.e., the unsummarized TLVs of the summary OID). Then the hash function value of the prefix TLVs is compared with the hash function value of the node identities of the backbone. It is recognized that it is advantageous to determine the BLRN based on the prefix TLVs of the summary OID because the prefix TLVs do not change as the number of summarized OIDs change.

For example, the BLRN may be the node in the backbone whose identity hash function value is closest but not greater than the hash function value of the prefix TLVs of the summary OID. Alternatively, the BLRN may be one or more nodes whose identity hash function value is closest to the hash function value of the prefix TLVs of the summary OID.

After determining the BLRN for a summary OID, an ABN may send the SLO associated with the summary OID to the BLRN. The BLRN may retain the SLO and service requests for content from routing areas, domains, or autonomous systems. The BLRN may also receive SLOs for which the BLRN is designated as a location resolver from other ABNs in the backbone hash ring.

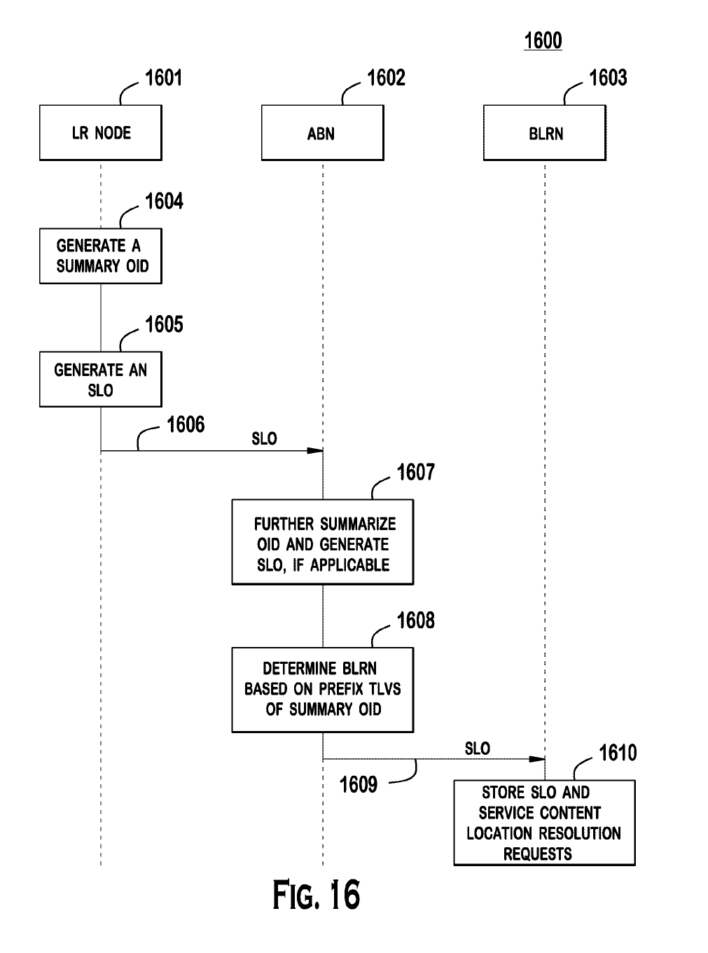

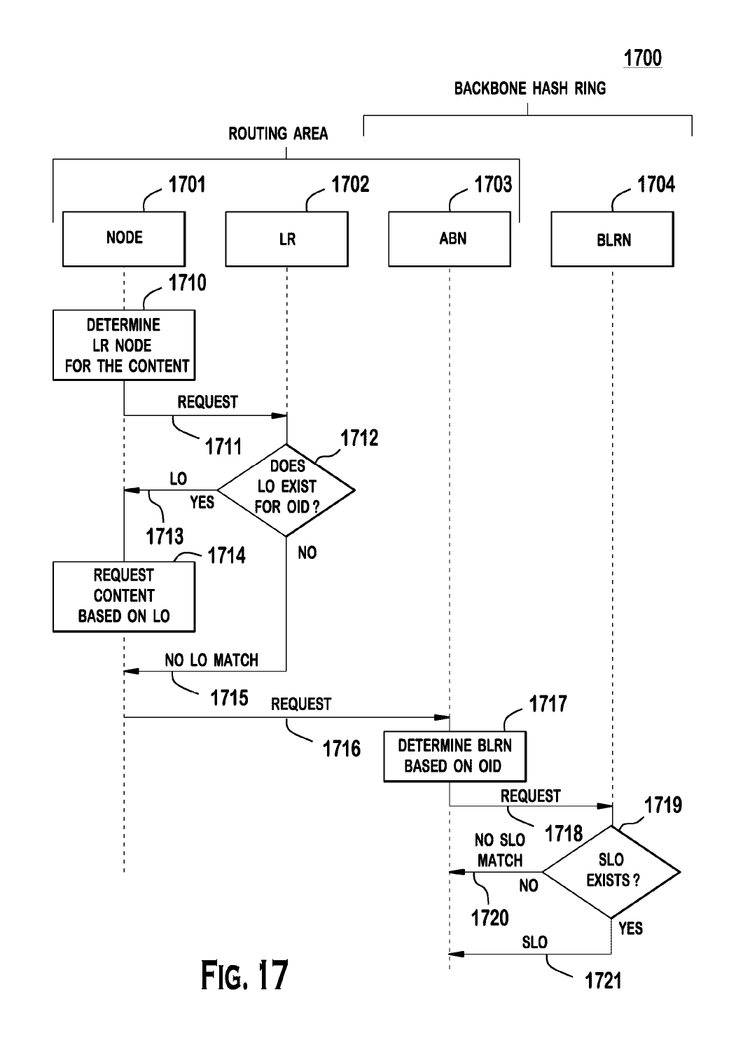

FIG. 16 shows a flow diagram of a method for publishing an SLO. An LR node 1601 generates a summary OID 1604. The summary OID is generated for content having the same prefix TLVs. The LR node 1601 also generates an SLO for the summary OID 1605. The LR node 1601 sends the SLO to an ABN 1602 1606. The ABN 1602 may belong to the routing area of the LR node 1601.

The ABN 1602 may further summarize the summary OID 1607, (i.e., if the ABN receives two or more SLOs having the same prefix TLVs). The ABN 1602 may also determine a BLRN 1603 based on the prefix TLVs of the summary OID 1608. The ABN 1602 may send the SLO to the BLRN 1603 1609. The BLRN 1603 stores the SLO and services content location resolution requests based on the SLO 1610.

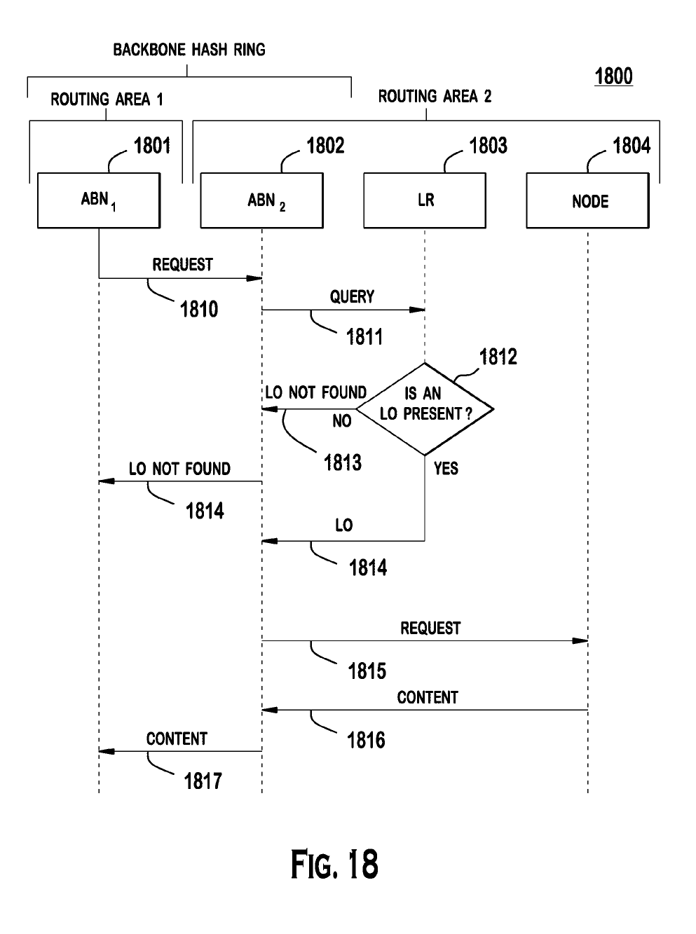

FIG. 17 shows a flow diagram of a method for retrieving content based on an OID. In the method 1700, a node 1701 seeks to request content based on an OID of the content. The node 1701 determines an LR node for the content 1710. The node 1701 sends a request for content to the LR 1711. The LR determines whether the LR has an LO for the content 1712.

If the LR node determines that it has an LO for the content, the LR sends the LO to the node 1701 1713. The node 1701 requests the content based on the LO 1714, (i.e., the node 1701 determines a publishing node of the content based on the LO and sends a request for content to the publishing node, which retrieves the content from a storing node). Alternatively, the LR 1702 may retrieve the content on behalf of the node 1701.

If the LR determines that it does not have an LO for the content, the LR sends a response to the node indicating that an LO match is not found 1715. The node 1701 may inquire as to whether the content is stored by a node in another routing area.

The node 1701 may also send a request to an ABN 1703 1716. The ABN 1703 is part of the routing area of the node 1701 and is also part of a backbone hash ring. The ABN 1703 determines a BLRN 1704 of the content based on the OID 1717. The BLRN 1704 is part of the backbone hash ring and may also be part of a routing area that is different than the routing area of the node 1701.

The ABN 1703 sends a request for content to the BLRN 1704 1718. The BLRN 1704 determines whether it has an SLO for the content 1719. If the BLRN 1704 determines that the BLRN has an SLO for the content, the BLRN 1704 responds to the ABN 1703 with the SLO 1720. Further, if the BLRN 1704 determines that the BLRN 1704 has more than one SLO for the content, the BLRN 1704 responds to the ABN 1703 with the more than one corresponding SLOs. Multiple corresponding SLO may indicate that multiple nodes may publish the content. Further, nodes that publish the content may be in different routing areas. The ABN 1703 may request the content on behalf of the node 1701.

It is recognized that due to OID summarization in SLOs, false positives may occur, (i.e., an ABN 1703 may receive an SLO from the BLRN 1704 when in fact the content is not stored as indicated by the SLO). In order to minimize the delay incurred in requesting content based on an SLO that is a false positive, upon receiving multiple SLOs, the ABN 1703 may send requests for the content at once based on all the SLOs, (i.e., in parallel). Alternatively, an ABN 1703 may issue a request for content based on one SLO then wait to receive the content or receive an indication that the content is not found before issuing another request for content based on another SLO.

FIG. 18 shows a flow diagram of a method for retrieving content. In the method 1800, ABN₁ 1801, (for example, ABN 1703 in FIG. 17), has received an SLO associated with desired content as described with reference to FIG. 17. ABN₁ 1801 is part of Routing Area 1 and the SLO indicates that a node in Routing Area 2 may publish the content. ABN₁ 1801 is also part of a backbone hash ring along with ABN₂ 1802, whereby ABN₂ 1802 is part of Routing Area 2. ABN₁ 1801 sends a request for content to ABN₂ 1802 1810. ABN₂ 1802 queries LR 1803 of Routing Area 2 as to whether the LR 1803 has an LO for the content 1811. Based on the OID of the content, the LR 1803 determines whether it has an LO for the content 1812. If the LR 1803 determines that it does not have an LO for the content, the LR 1803 indicates to ABN₂ 1802 that an LO is not found 1813. ANB₂ 1802 indicates to ABN₁ 1801 that an LO is not found for the content. Therefore, a false positive due to OID summarization has occurred. ABN₁ 1801 may attempt to retrieve based on another SLO if there are any.

If the LR 1803 determines that an LO for the content is present, the LR 1803 provides the LO to ABN₂ 1802 1814. The LO indicates the node publishing the content, (i.e., node 1804). ABN₂ 1802 may then request the content from node 1804 1815 and node 1804 may retrieve the content from a storing node and provide the content to ABN₂ 1802 1816. ABN₂ 1802 may in turn provide the content to ABN₁ 1801. ABN₁ 1801 may also provide the content to a node in Routing Area 1 (not shown).

A request for content, for example, request 1810 and request 1815, may, therefore, be forwarded along the shortest path in a network, for example, from ABN₁ 1801 to ABN₂ 1802 and then to publishing node 1804 and any storage node. The requested content, for example, content 1816 and 1817, (or, in some embodiments, an indication to establish a content retrieval session, for example) may be sent to the requester along the same path, for example, from a storing node to publishing node 1804 to ABN₂ 1802 and then to ABN₁ 1801. Content caching may be performed by any intermediary node along the path.

Multi-level topology-aware one-hop DHTs may be utilized to provide distributed content resolution and efficiently locate content. As described herein, the closest copy of a particular content object is located. Further, OID resolution is integrated into the routing and forwarding process. Additionally, OID summarization is used in higher-level DHTs to reduce control overhead and state requirements for better scalability.

In an embodiment, an OID may be self-certifying and flat having the form of P:L, where P represents a cryptographic hash of a principal's public key, L represents a flat label, and the colon represents a delimiter. Different content may have the same P value but differing L values. For example, a first content may have an OID of P:L₁, a second content may have an OID of P:L₂, and an Nth content may have an OID of P:L_{N}. A summary OID may be generated by applying a Bloom filter to the L values, where the summary OID may be P:digest(L) and the digest(L) is generated by applying a Bloom filter to L₁, L₂, . . . , L_{N}, i.e., digest(L)=Bloom-Filter{L₁, L₂, . . . , L_{N}}.

In another embodiment, Bloom filter summarization may be applied to hierarchical OIDs such as /example.com/news/title. For example, a summary OID of the form of /example.com/news/digest(titles) may be used to summarize content whose name or OID starts with the same prefix, /example.com/news, but having differing titles.

Similarly content having a name or OID of /example.com/category/title may be summarized by applying a Bloom filter to both the category and title. For example, a summary OID of /example.com/digest(categories/titles) may be generated for content having differing categories and titles but a common prefix of /example.com.

As previously described, to query whether an OID was utilized in generating a summary OID, the unsummarized portion of the summary OID, i.e., the prefix of the summary OID, may match the prefix of the OID, whereas the digest of the summary OID is required to yield a positive test indicating that the corresponding suffix element in the queried OID was used in generating the summary OID.

The likelihood of false positives may also be controlled by designing appropriate Bloom filters. Given a Bloom filter, a node may control the number of OIDs used in generating a summary OID based on the popularity of content or based on a distance to the content location thus balancing between network resource and the likelihood of false positives. For example, content residing in a local network domain may not be summarized if the content is likely to be requested with a high probability from within. However, a domain may utilize summarization for publishing the content within the domain to outside other domains.

As previously described the number of OIDs used to generate a summary OID may be limited to control the probability of false positives. When the number of OIDs exceeds the limit, the OIDs are divided into groups, whereby each group may be used to generate a digest as follows:

P:digest1(L):digest2(L):digest3(L).

In one embodiment, an OID may be made a secure OID. In a secure OID, a publisher code is a public key of the publisher or a hash value of a public key of the publisher. Further, a secure OID may be signed by generating a signature using a private key associated with a public key of the publisher. The signature may be appended to the OID to form a self-certifying OID. By checking the signature, the authenticity of content may be verified.

In another embodiment, an OID may be appended with an OID length field, whereby the OID length field represents the length of the OID, (for example, the total size (in bits or bytes), of the OID). In an embodiment, an OID for content may be generated by applying a hash function to the file of the content, or by applying a hash function to a name of the content, (for example, a human-readable name such as a movie title or a song title).

A secure ID may be created by an assignor and may take the form of Assignor Code:Assignee ID:Signature. The colon in the secure OID is a delimiter that may not be present in the secure ID. In the secure ID, the Assignor Code is a public key or a hash value of a public key of the assigner. The Assignee ID is an ID assigned by the assigner.

The secure ID may also be self-certifying and hierarchical. The secure ID may be concatenated to form a tree. For example, Assignor 1 Code:Assignee 2 ID:Signature 1:Assignor 2 Code:Assignee 3 ID:Signature 2 may be a secure ID, where Assignor 1 has assigned an ID (Assignee 2 ID) to Assignor 2. Further, Assignor 2, having a code of Assignor 2 Code, has assigned an ID to Assignor 3 (Assignee 3 ID). Assignor 2 ID may be a public key of Assignor 2 or a hash value of the public key of Assignor 2. Further, Assignor 2 code may be the same as Assignor 2 ID, (for example, Assignor 2 public key or a hash value of a public key of Assignor 2).

It is recognized that OID summarization may be performed at any tier in a network, (for example, Autonomous System or domain), and SLOs may generated and propagated up in a network's hierarchy to a higher tier as described herein. Further, a network's higher tiers may be queried for content as described herein, (for example, upon exhausting content retrieval alternatives in lower network tiers). OID summarization using Bloom filters is advantageous in that it results in a reduction of update overhead and achieves network scalability while relieving the suffix hole disadvantages of prefix-based summarization.

It is also recognized that when a node is added to a hash ring, (for example, hash ring 1311 of FIG. 13), or when a node of the hash ring becomes defective or experiences a failure, a content's designated LR may change accordingly. Nodes in a routing area may monitor a link-state protocol, (for example OSPF), for information about node additions or deletions and upon determining that due to a node addition or deletion a designated LR of content has changed to a new LR, the node may send the content's LO to the new LR. Further, nodes in a routing area may be configured to periodically send a content's LO to the designated LR.

Similarly, ABNs of a backbone hash ring, (for example, backbone hash ring 1314), may monitor a link-state protocol for information about ABN additions or deletions and may send an SLO to a new BLRN upon detecting a change in BLRN designation. Additionally, ABNs may be configured to periodically send an SLO to a designated BLRN.

Further, an LO maintained by an LR that is no longer a designated LR for a content will eventually expire at the expiration of the timeout field. Similarly, an SLO maintained by a BLRN that is no longer a designated BLRN will also expire at the expiration of the timeout field.

In an embodiment, multiple LR nodes for a content may be determined using multiple hash functions, or multiple keys of a hash function. Further, an LO for the content may be sent to and maintained by the multiple LR nodes. Similarly, multiple BLRN nodes may be determined using multiple hash functions, or multiple keys of a hash function and an SLO may be sent to and maintained by the multiple BLRN nodes.

In one embodiment, routing based on OID may be a layer in a protocol stack above the IP layer and below a user datagram protocol (UDP) or a transmission control protocol (TCP) of the transport layer.

In another embodiment, an IP header of a request for content may include a frame offset field, an identification field, or a flag field. The frame offset field, identification field, or flag field may be used to identify a fragment of an IP datagram, such as content. An offset indicated by the offset field may be relative to a beginning of an original unfragmented IP datagram.

### EMBODIMENTS

1. A method for content identification, routing, and retrieval in the internet.

2. The method of embodiment 1 comprising: utilizing an object identifier (OID) for content identification.

3. The method as in any one of the preceding embodiments wherein the OID comprises type-length-value (TLV) fields.

4. The method as in any one of the preceding embodiments wherein a TLV field is comprised of a type field, a length field, and a value field.

5. The method as in any one of the preceding embodiments wherein type field represents the type of the TLV field, the length field represents the length of the TLV field, the value field represents the value of the TLV.

6. The method as in any one of the preceding embodiments comprising: utilizing an OID to identify a device, or a node in a network

7. The method as in any one of the preceding embodiments comprising: processing a content's OID and retrieving content based on the content's OID.

8. The method as in any one of the preceding embodiments comprising: processing an Internet Protocol (IP) addresses and retrieving content based on the IP address of where content is stored

9. The method as in any one of the preceding embodiments comprising: processing both an OID and an IP address and retrieving content based upon any combination of the content's OID or an IP address of where the content is stored.

10. The method as in any one of the preceding embodiments comprising: sending a request for content to a network.

11. The method as in any one of the preceding embodiments comprising: routing and propagating the request for content based on an IP address, an OID, or both an IP address and an OID.

12. The method as in any one of the preceding embodiments wherein the request for content includes an IP field and an OID field.

13. The method as in any one of the preceding embodiments comprising: exchanging with another node OIDs of content that is stored.

14. The method as in any one of the preceding embodiments comprising: maintaining a directory associating an OID with another node that stores the content of the OID.

15. The method as in any one of the preceding embodiments comprising: routing a request for content to node that stores the content.

16. The method as in any one of the preceding embodiments comprising: maintaining a local cache of content.

17. The method as in any one of the preceding embodiments comprising: setting a content location resolved flag on a condition that a second node stores the content.

18. The method as in any one of the preceding embodiments comprising: setting an expiration for the request for content.

19. The method as in embodiment 18 wherein the expiration is represented by a time-to-live (TTL) field.

20. The method as in any one of the preceding embodiments comprising: reissuing a request for content with an incremented TTL.

21. The method as in any one of the preceding embodiments comprising: receiving information about the identities and the capabilities of other nodes in a network.

22. The method as in any one of the preceding embodiments wherein a node is designated as a location resolver (LR) of particular content and is assigned the responsibility of identifying the location of where the content is stored.

23. The method as in any one of the preceding embodiments comprising: determining an LR by applying a hash function to a node identity to produce a first hash function value and applying a hash function to an OID of content to produce a second hash function value and comparing the first hash function value with the second hash function value.

24. The method as in any one of the preceding embodiments further comprising: sending a location object (LO) to the LR.

25. The method as in any one of the preceding embodiments comprising: generating a summary OID.

26. The method as in embodiment 25 comprising: sending the summary OID to an area border node (ABN).

27. The method as in any one embodiments 25 or 26 wherein the summary OID is generated by applying a Bloom filter to OIDs.

28. The method as in any one of the preceding embodiments comprising: testing the summary OID to determine whether an OID of interest is one of the OIDs used to generate the summary OID.

29. The method as in any one of the preceding embodiments comprising: generating a summary location object (SLO) based on a summary OID.

30. The method as in any one of the preceding embodiments comprising: further summarizing two SLOs by retaining prefix TLVs and generating new digest TLVs based on ORing the digests of the digest TLVs.

31. The method as in any one of the preceding embodiments comprising: designating a backbone location resolver node (BLRN) for an SLO.

32. A node in an Internet Protocol (IP) network comprising: a receiver configured to receive one or more object identifiers (OIDs); a processor configured to generate a summary OID based on the one or more OIDs by applying a Bloom filter to the one or more OIDs; and a transmitter configured to transmit the summary OID.

33. The node of embodiment 32, wherein the summary OID is comprised of type-length-value (TLV) fields.

34. The node of embodiment 33, wherein a prefix TLV field of the summary OID is the same as a prefix TLV of the one or more received OIDs.

35. The node of embodiment 33, wherein a suffix TLV field of the summary OID is generated by applying a Bloom filter to a suffix TLV of the one or more received OIDs to generate a digest and by appending a type field, a value field, and a number of OIDs summarized field to the digest to produce the suffix TLV.

36. The node of embodiment 32, wherein the summary OID is capable of being tested to determine whether an OID is one of the one or more received OIDs.

37. A node in an Internet Protocol (IP) network comprising: a processor configured to determine a location resolver (LR) node associated with content based on an object identifier (OID) associated with the content by applying a hash function to the OID associated with the content to produce a first hash function value and by applying the hash function to an identity associated with each of a plurality of nodes to produce a plurality of second hash function values, and by comparing the first hash function value to the plurality of second hash function values to determine an LR node associated with the content; and a transmitter configured to send a location object (LO) associated with the content to the determined LR node.

38. The node of embodiment 37, wherein the first hash function value is greater than or equal to the second hash function value for the determined LR node.

39. The node of embodiment 37, wherein the LO comprises the OID associated with the content.

40. The node of embodiment 39, wherein the LO further comprises an identity of a node storing the content, a scope field, and a timeout field.

41. A content delivery network (CDN) comprising: a first node comprising: a first node receiver configured to receive a request for content, the request for content identifying content using an object identifier (OID) associated the content; and a first node processor configured to determine whether the content is stored in a local cache of the first node based on the OID associated the content, wherein on a condition that the content is not stored in the local cache of the first node, the first node further comprises a first node transmitter configured to send the request for content to a second node; and a second node comprising: a second node receiver configured to receive the request for content from the first node; and a second processor configured to determine whether a location object (LO) is maintained for the content, wherein on a condition that an LO is maintained for the content, the second node further comprises a second node transmitter configured to send to the first node an indication of a location for retrieval of the content.

42. The CDN of embodiment 41, wherein the second node is a location resolver (LR) node.

43. The CDN of embodiment 42, wherein the first node is configured to determine the second node by applying a hash function to the OID associated with the content to produce a first hash function value and by applying the hash function to an identity associated with each of a plurality of nodes to produce a plurality of second hash function values, and by comparing the first hash function value to the plurality of second hash function values to determine the second node.

44. The CDN of embodiment 41, wherein the first node transmitter is further configured, on a condition that the content is stored in the local cache of the first node, to provide the content.

45. The CDN of embodiment 41, wherein the OID of the content is comprised of type-length-value (TLV) fields.

46. An Internet-enabled device for requesting content from a network, the device comprising: a processor configured to generate a request for content, wherein the request for content comprises an object identifier (OID) associated with the content, and wherein the OID comprises one or more type-length-value (TLV) fields; and a transmitter configured to transmit the request for content comprising the OID to a node of the network.

47. The Internet-enabled device of embodiment 46, wherein a value field of the OID comprises a country or group code, a publisher code, a title code, a format or type code, a timestamp, or a duration.

48. A base station configured to perform a method as in any one of embodiments 1-31.

49. An evolved Node B configured to perform a method as in any one of embodiments 1-31.

50. A Node B configured to perform a method as in any one of embodiments 1-31.

51. An integrated circuit configured to perform a method as in any one of embodiments 1-31.

52. A method as in any one of embodiments 1-31 performed in Institute of Electrical and Electronics Engineers (IEEE) 802.11.

53. A method as in any one of embodiments 1-31 performed in Long Term Evolution (LTE) wireless communications.

54. A method as in any one of embodiments 1-31 performed in Long Term Evolution-Advanced (LTE-A) wireless communications.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A node in an Internet Protocol (IP) network comprising:
a receiver configured to receive one or more object identifiers (OIDs), wherein the one or more OIDs have an identical prefix OID;
a processor configured to generate a summary OID comprising the prefix OID and a suffix summary OID, the suffix summary OID having a digest, wherein the digest is generated based on the one or more OIDs by applying a Bloom filter to suffixes of the one or more OIDs; and
a transmitter configured to transmit the summary OID.

2. The node of claim 1, wherein the summary OID comprises type-length-value (TLV) fields.

3. The node of claim 2, wherein a prefix TLV field of the summary OID is the same as a prefix TLV of the one or more received OIDs.

4. The node of claim 2, wherein a type field, a value field, and a number of OIDs summarized field are appended to the digest to produce the suffix TLV.

5. The node of claim 1, wherein the summary OID is capable of being tested to determine whether an OID is one of the one or more received OIDs.

6-9. (canceled)

10. A content delivery network (CDN) comprising:
a first node comprising:
a first node receiver configured to receive a request for content, the request for content identifying content using an object identifier (OID) associated with the content; and
a first node processor configured to determine whether the content is stored in a local cache of the first node based on the OID associated with the content, wherein on a condition that the content is not stored in the local cache of the first node, the first node further comprises a first node transmitter configured to send the request for content to a second node; and
a second node comprising:
a second node receiver configured to receive the request for content from the first node; and
a second node processor configured to determine whether a location object (LO) is maintained for the content, wherein the LO includes a scope field, and a timeout field, and wherein on a condition that the LO is maintained for the content, the second node further comprising a second node transmitter configured to send the LO to the first node.

11. The CDN of claim 10, wherein the second node is a location resolver (LR) node.

12. The CDN of claim 11, wherein the first node is configured to determine the second node by applying a hash function to the OID associated with the content to produce a first hash function value and by applying the hash function to an identity associated with each of a plurality of nodes to produce a plurality of second hash function values, and by comparing the first hash function value to the plurality of second hash function values to determine the second node.

13. The CDN of claim 10, wherein the first node transmitter is further configured, on a condition that the content is stored in the local cache of the first node, to provide the content.

14. The CDN of claim 10, wherein the OID of the content comprises type-length-value (TLV) fields.

15. An Internet-enabled device for requesting content from a network, the device comprising:
a processor configured to generate a request for content, wherein the request for content comprises an object identifier (OID) associated with the content, and wherein the OID comprises one or more type-length-value (TLV) fields; and
a transmitter configured to transmit the request for content comprising the OID to a node of the network.

16. The Internet-enabled device of claim 15, wherein a value field of the OID comprises a country or group code, a publisher code, a title code, a format or type code, a timestamp, or a duration.
